(19) United States
(12) Patent Application Publication
(10) Pub. No.: US 2009/0029009 A1
(43) Pub. Date: Jan. 29, 2009

(54) SPORTS DRINK CONTAINING RICE SYRUP AND AGAVE NECTAR

(76) Inventors: Dimitri St. Phard, Princeton, NJ (US); Nancy Dince, Princeton, NJ (US)

Correspondence Address: DICKSTEIN SHAPIRO LLP, 1825 EYE STREET NW, Washington, DC, 20006-5403, US

(21) Appl. No.: 11/782,398

(22) Filed: Jul. 24, 2007

(51) Int. Cl. A23L 2/52

(52) U.S. Cl. 426/74

(57) ABSTRACT

An all natural beverage comprised of rice syrup, agave nectar, fruit juice and electrolytes. The beverage is useful for rapid hydration and replenishment of lost carbohydrates and electrolytes after exercise, physical exertion, or exposure to heat.

### FIELD OF THE INVENTION

The present invention relates to the composition of an all-natural beverage containing rice syrup, agave nectar, and electrolytes, for use primarily, but not exclusively, by individuals engaged in sports or other endurance activities.

### BACKGROUND OF THE INVENTION

It is well known that increased physical activity places greater metabolic demands on the human body. During exercise, sporting events or other endurance activities, perspiration is lost from the body, resulting in dehydration and the loss of essential electrolytes. In addition, the body's major carbohydrate stores—such as muscle glycogen, liver glycogen and plasma glucose—may become depleted. Fatigue, muscle cramping, and impaired mental concentration often results. Even moderate activity can lead to decreased glucose levels and dehydration, especially in hot and/or humid climates.

Numerous beverages have been developed to address the body's need for water, electrolytes, and carbohydrates; however, most of these beverages include high fructose corn syrup as the main component for replenishing the body's carbohydrate needs. High fructose corn syrup has been cited as a possible contributor to obesity. Rather than replacing the body's carbohydrate needs and maintaining steady blood glucose levels, high fructose corn syrup may be processed by the body like fat, causing increased hunger and thirst after consumption. This in turn, may defeat the purpose of the exercise or endurance activity.

### BRIEF SUMMARY OF THE INVENTION

The present invention overcomes the deficiencies of the above noted prior art beverages by combining three all natural sweeteners—rice syrup, agave nectar, and fruit juice—allowing athletes to recover and hydrate faster and feel energized for a longer period of time. The restorative health benefits of rice have been well documented and used throughout the world for the treatment of dehydration, disease and malnutrition. A rice syrup base combined with agave nectar, fruit juice, and an optimized electrolyte mix, creates an ideal vehicle for re-hydration and recovery.

The detailed description herein illustrates these and other embodiments and serves to explain the principles of the invention. Other features and advantages of the present invention will also become apparent to those skilled in the art from the following description of the invention.

### DETAILED DESCRIPTION OF THE INVENTION

The present invention is an all-natural beverage containing filtered water, rice syrup, agave nectar, fruit juice, and electrolytes. The beverage is particularly useful for rapidly re-hydrating and replenishing lost fluid, carbohydrates and electrolytes after exercise, physical exertion, or exposure to heat. For example, an athlete engaged in strenuous activity requires a ready source of energy for endurance, and replacement of body fluids and essential salts lost through perspiration. Also, blood glucose levels may decrease after continued exercise or other endurance activities, leading to increased fatigue.

The present invention provides a balanced source of sugars and essential salts using all natural ingredients, without the use of high fructose corn syrup or crystalline fructose. Furthermore, the precise mix of various types of sugars that are present in rice syrup, agave nectar and fruit juice helps users maintain a more steady blood sugar level after consumption.

Rice syrup is a sweetener made from whole grain rice that has been cultured and fermented with enzymes to break down the natural starches into complex carbohydrates and more simple carbohydrates, maltose, and glucose. This mixture of simple and complex carbohydrates enables the sugars to be absorbed more slowly by the digestive system, resulting in a more steady level of blood glucose levels than obtained by other sweeteners. The glucose is absorbed immediately, while the maltose and complex carbohydrates absorb over several hours. Rice syrup contains only half the sweetness of common refined sugar.

Preferably, the rice syrup is lightly-filtered, non-clarified white rice syrup 26 DE, although rice syrup with different DE levels may be substituted. The sugar profile of the preferred rice syrup is: glucose—6 g/100 g; maltose—13 g/100 g; other carbohydrates—57 g/100 g.

Agave nectar is cultivated from the agave plant, a succulent grown in Mexico. The nectar contains approximately 75% fructose, and does not require any chemicals for processing. Unlike the crystalline form of fructose which is refined primarily from corn, agave nectar is fructose in its natural form and also contains other natural flavors. Agave nectar is at least 25% sweeter than common refined sugar. Agave nectar has a relatively low glycemic index due to its higher proportion of fructose and lower levels of glucose.

Preferably, light grade agave nectar is used, although blue, amber or dark grades may be substituted. The sugar profile of the preferred light amber grade agave nectar is: fructose—70.5 to 74.5%; dextrose—20.5 to 26.5%; other carbohydrates—0 to 5.0%.

The beverage of the present invention also contains a fruit juice concentrate, which supplies additional sugars as well as organoleptically pleasing flavors. In the preferred embodiments, lemon, orange or raspberry fruit juice concentrate is used depending on the flavor desired. However, other natural fruit juices may be substituted depending on the desired flavor. Additionally, natural flavoring may be used to enhance the flavor of the beverage.

In the preferred embodiment, sodium chloride and monopotassium phosphate are included as electrolytes. Preferably, the amount of sodium chloride ranges from 0.05% to 1.0% w/v, while the amount of monopotassium phosphate ranges from 0.01% to 2.5% w/v. In addition to sodium chloride and monopotassium phosphate, other physiologically important electrolytes may also be used.

Yet another embodiment of the present invention utilizes all certified-organic ingredients to create an organic version of the invention.

The primary method for preparing the beverage is by mixing rice syrup with filtered water in a kettle. Agave nectar, fruit juice concentrate, sodium chloride, monopotassium phosphate, citric acid and malic acid are then added. Since the acidity and sugar content of the raw materials may fluctuate, Brix and pH measurements of the solution are taken. Additional acid, rice syrup or agave nectar may be added to adjust the acidity and sugar concentrations to optimal levels. Finally, natural colors and flavors are added and the entire solution is pasteurized.

In the preferred embodiments, the pH level of the beverages range from 2.5 to 2.9. However, pH levels may vary depending on the particular flavor profile desired. Thus, the present invention envisions a pH range of 2.4 to 4.5. The pH of the beverage may be adjusted by the addition of an edible acid, such as citric acid or malic acid, or by the addition of other compounds known in the art.

Brix is a measurement of the concentration of dissolved solids in a solution and is related to the amount of sugar in the solution. In the preferred embodiment, the Brix level of the beverage is 7.0. However, Brix levels may vary depending on the particular flavor desired. Thus, the present invention envisions a Brix range of 5.0 to 15.0.

The beverage compositions presented below are only illustrative as the preferred embodiment for each flavor and are not intended to limit the invention in any way. The actual concentrations of the ingredients may vary according to intended use. However, maximum concentrations within organoleptically acceptable limits yielded the following results:

Organoleptic Evaluation of the Maximum Concentrations
for Certain Ingredients

| | Maximum | | |
|---|---|---|---|
| Ingredient | Concentration (w/v) | Appearance or Consistency | Flavor |
| White rice syrup | 35% | Heavy mouthfeel, syrup- | sweet flavor, |
| (26 DE) | | nectarlike consistency | bran notes |
| Agave nectar | 50% | Heavy mouthfeel, syrup- | sweet flavor |
| | | nectarlike consistency | |
| Sodium Chloride | 1.0% | slightly cloudy solution | salty flavor |
| Monopotassium | 2.5% | Clear | salty, sour, slight |
| phosphate | | | bitter flavor |

The following examples further describe and demonstrate features of the present invention. The examples are given solely for the illustration purposes and are not to be construed as a limitation of the present invention.

In one embodiment, Example 1, a berry flavor beverage is developed with the following composition of ingredients:

### EXAMPLE 1

| | Amount |
|---|---|
| Ingredients | (weight/volume) |
| Rice syrup | 1.30% |
| Agave nectar | 6.40% |
| Raspberry juice concentrate | 1.20% |
| Sodium chloride | 0.12% |
| Monopotassium phosphate | 0.025% |
| Malic acid | 0.10% |
| Citric acid | 0.05% |
| Natural flavoring | 0.18% |
| Water | remainder |

In another embodiment, Example 2, a lemon flavored beverage is obtained using the following composition of ingredients:

### EXAMPLE 2

| | Amount |
|---|---|
| Ingredients | (weight/volume) |
| Rice syrup | 1.60% |
| Agave nectar | 7.05% |
| Lemon juice concentrate | 0.50% |
| Sodium chloride | 0.11% |
| Monopotassium phosphate | 0.05% |
| Citric acid | 0.20% |
| Natural flavoring | 0.20% |
| Water | remainder |

In another embodiment, Example 3, an orange flavored beverage is obtained using the following composition of ingredients:

### EXAMPLE 3

| | Amount |
|---|---|
| Ingredients | (weight/volume) |
| Rice syrup | 1.50% |
| Agave nectar | 6.30% |
| Orange juice concentrate | 1.20% |
| Sodium chloride | 0.10% |
| Monopotassium phosphate | 0.07% |
| Citric acid | 0.13% |
| Beta Carotene | 0.025% |
| Natural flavoring | 0.50% |
| Water | remainder |

Finally, in another embodiment, Example 4, a citrus-passion fruit flavored beverage is obtained using the following composition of ingredients:

### EXAMPLE 4

| Ingredients | Amount (w/v) |
|---|---|
| Rice syrup | 1.50% |
| Agave nectar | 6.70% |
| Lemon juice concentrate | 0.22% |
| Purple elderberry juice concentrate | 0.03% |
| Passion fruit juice concentrate | 0.02% |
| Sodium chloride | 0.10% |
| Monopotassium phosphate | 0.06% |
| Malic acid | 0.10% |
| Citric acid | 0.15% |
| Natural flavoring | 0.20% |
| Water | remainder |

While the present invention has been described with respect to particular disclosed embodiments, it should be understood that numerous other embodiments are within the scope of the present invention. It will be apparent to one of ordinary skill in the art that many of changes of modifications can be made without departing from the spirit or scope of the invention as defined in the following claims.

What is claimed is:

1. An all-natural beverage comprising water, rice syrup, agave nectar, fruit juice and physiologically essential electrolytes.

2. The beverage of claim 1, wherein said electrolytes comprise sodium, potassium and phosphate.

3. The beverage of claim 1, wherein the concentration of rice syrup is 0.5% to 10.0% weight/volume.

4. The beverage of claim 1, wherein the concentration of agave nectar is 3.0% to 14.0% weight/volume.

5. The beverage of claim 1, wherein the concentration of fruit juice is 0.2% to 11.0% weight/volume.

6. A method for hydration and replenishment of lost carbohydrate stores in a human body, by consuming an all-natural beverage comprising water, rice syrup, agave nectar, fruit juice and physiologically essential electrolytes.

7. A method of claim 6, wherein said electrolytes comprise sodium, potassium and phosphate.
